(19) United States
(12) Patent Application Publication
(10) Pub. No.: US 2025/0313093 A1
(43) Pub. Date: Oct. 9, 2025

(54) ELECTRIC ALL-WHEEL-DRIVE VEHICLE

(71) Applicant: SUBARU CORPORATION, Tokyo (JP)

(72) Inventors: Minoru SUYAMA, Tokyo (JP); Takahiro YAMADA, Tokyo (JP)

(21) Appl. No.: 19/077,568

(22) Filed: Mar. 12, 2025

(30) Foreign Application Priority Data
Apr. 5, 2024 (JP) 2024-061567

(51) Int. Cl. B60L 15/20

(52) U.S. Cl. CPC B60L 15/2036; B60L 2240/425; B60L 2240/461; B60L 2240/463; B60L 2260/28

(57) ABSTRACT

An electric all-wheel-drive vehicle includes front and rear electric motors, an accelerator sensor, front and rear wheel speed sensors, and one or more processors. The one or more processors are configured to, when a predetermined learning condition is established, vary output torque of the rear electric motor and output torque of the front electric motor, while satisfying requested torque, to learn longitudinal differential rotation at which total power consumption or total torque of the front electric motor and the rear electric motor is minimized. The one or more processors are configured to, after learning the longitudinal differential rotation, control the output torque of the front electric motor and the output torque of the rear electric motor to allow actual longitudinal differential rotation to match with the learned longitudinal differential rotation.

### CROSS REFERENCE TO RELATED APPLICATIONS

The present application claims priority from Japanese Patent Application No. 2024-061567 filed on Apr. 5, 2024, the entire contents of which are hereby incorporated by reference.

### BACKGROUND

The disclosure relates to an electric all-wheel-drive vehicle.

Electric vehicles have been put into practical use recently. Electric vehicles use an electric motor as a source of a driving force and do not discharge exhaust gas. For example, Japanese Unexamined Patent Application Publication (JP-A) No. 2018-93646 discloses an electric all-wheel-drive vehicle in which front wheels are driven by a front motor and rear wheels are driven by a rear motor.

### SUMMARY

An aspect of the disclosure provides an electric all-wheel-drive vehicle including a front electric motor, a rear electric motor, an accelerator sensor, a front wheel speed sensor, a rear wheel speed sensor, and one or more processors. The front electric motor is configured to drive a front wheel. The rear electric motor is configured to drive a rear wheel. The accelerator sensor is configured to detect an amount of operation of an accelerator. The front wheel speed sensor is configured to detect the number of rotations of the front wheel. The rear wheel speed sensor is configured to detect the number of rotations of the rear wheel. The one or more processors are configured to control the front electric motor and the rear electric motor based on the amount of operation of the accelerator, the number of rotations of the front wheel, and the number of rotations of the rear wheel. The one or more processors are configured to, when a predetermined learning condition is established, vary output torque of the rear electric motor and output torque of the front electric motor, while satisfying requested torque, to learn longitudinal differential rotation at which total power consumption or total torque of the front electric motor and the rear electric motor is minimized. The longitudinal differential rotation is a difference between the number of rotations of the front wheel and the number of rotations of the rear wheel. The one or more processors are configured to, after learning the longitudinal differential rotation, control the output torque of the front electric motor and the output torque of the rear electric motor to allow actual longitudinal differential rotation to match with the learned longitudinal differential rotation.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 illustrates an overall configuration of an electric all-wheel-drive vehicle according to an embodiment.

FIG. 2 illustrates output characteristics, or T-N characteristics, of a front motor generator and a rear motor generator.

FIG. 3 illustrates characteristics of, or relation between, a driving force and a tire slip, or a slip ratio.

FIG. 4 illustrates a learning method of a minimum value of total power consumption or total torque by the electric all-wheel-drive vehicle according to the embodiment.

FIG. 5 illustrates an example of a target longitudinal differential rotation map.

FIG. 6 is a flowchart of a processing procedure of learning processing of the longitudinal differential rotation by the electric all-wheel-drive vehicle according to the embodiment.

FIG. 7 is a flowchart of a processing procedure of a longitudinal differential rotation control by the electric all-wheel-drive vehicle according to the embodiment.

### DETAILED DESCRIPTION

For electric all-wheel-drive vehicles, what is desired is enhancement or improvement of electricity consumption (km/kWh or kWh/km). However, the electric all-wheel-drive vehicle described in JP-A No. 2018-93646 gives little consideration to the enhancement or improvement of the electricity consumption.

It is desirable to provide an electric all-wheel-drive vehicle in which front wheels are driven by a front electric motor and rear wheels are driven by a rear electric motor, and that makes it possible to improve electricity consumption.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

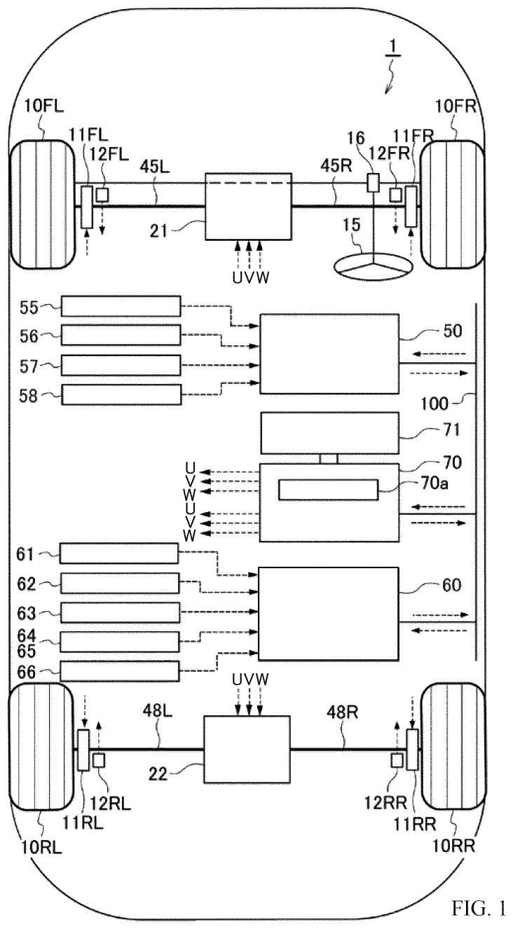

First, with reference to FIG. 1, description is given to a configuration of an electric all-wheel-drive vehicle (AWD BEV) 1 according to an embodiment. FIG. 1 illustrates an overall configuration of the electric all-wheel-drive vehicle 1.

A front motor generator 21 may be coupled to a left-front-wheel drive shaft 45L and a right-front-wheel drive shaft 45R through, for example, a gear, i.e., a front reduction gear, and a front differential, i.e., a front motor unit. In one embodiment of the disclosure, the front motor generator 21 may serve as a “front electric motor.” The left-front-wheel drive shaft 45L may be coupled to a left front wheel 10FL, and the right-front-wheel drive shaft 45R may be coupled to a right front wheel 10FR. That is, the front motor generator 21 may be torque-transmittably coupled to the front wheels 10FL and 10FR, and is configured to drive the front wheels 10FL and 10FR.

A rear motor generator 22 may be coupled to a left-rear-wheel drive shaft 48L and a right-rear-wheel drive shaft 48R through, for example, a gear, i.e., a rear reduction gear, and a rear differential, i.e., a rear motor unit. In one embodiment of the disclosure, the rear motor generator 22 may serve as a “rear electric motor.” The left-rear-wheel drive shaft 48L may be coupled to a left rear wheel 10RL, and the right-rear-wheel drive shaft 48R may be coupled to a right rear wheel 10RR. That is, the rear motor generator 22 may be torque-transmittably coupled to the rear wheels 10RL and 10RR, and is configured to drive the rear wheels 10RL and 10RR.

The front motor generator 21 and the rear motor generator 22 may each include a synchronous generator motor that serves as a motor configured to convert supplied electric power into a mechanical motive force and serves as a generator configured to convert an inputted mechanical motive force into electric power. That is, each of the front motor generator 21 and the rear motor generator 22 is configured to, when driving the vehicle, operate as a motor configured to generate driving torque and is configured to, during regeneration, operate as a generator.

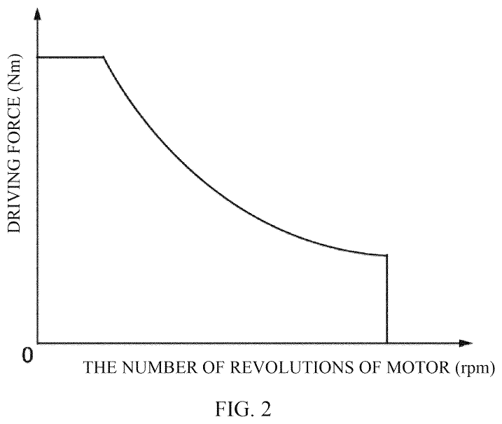

FIG. 2 illustrates output characteristics, or T-N characteristics, of the front motor generator 21 and the rear motor generator 22. In FIG. 2, the horizontal axis represents the number of revolutions of the motor (rpm), and the vertical axis represents a driving force (Nm). As illustrated in FIG. 2, the front motor generator 21 and the rear motor generator 22 have the T-N characteristics, that is, characteristics in which, in a range of the base number of revolutions or more, as the number of revolutions of the motor increases, the driving force, i.e., output torque, decreases because of an increase in an induced electromotive force, i.e., an induced voltage.

Back to FIG. 1, brakes 11FL to 11RR may be attached to the respective wheels 10FL to 10RR. The brakes 11FL to 11RR are configured to brake the wheels 10FL to 10RR. In the following, the wheels 10FL to 10RR are collectively referred to as wheels 10 and the brakes 11FL to 11RR are collectively referred to as brakes 11. Moreover, wheel speed sensors 12FL to 12RR may be attached to the respective wheels 10FL to 10RR. The wheel speed sensors 12FL to 12RR are each configured to detect a wheel rotation speed. In the following, the wheel speed sensors 12FL to 12RR are collectively referred to as wheel speed sensors 12. That is, the front wheel speed sensors 12FL and 12FR may be attached to the front wheels 10FL and 10FR, and the rear wheel speed sensors 12RL and 12RR may be attached to the rear wheels 10RL and 10RR. The front wheel speed sensors 12FL and 12FR are configured to detect the number of rotations, i.e., a rotation speed, of the front wheels 10FL and 10FR, respectively. The rear wheel speed sensors 12RL and 12RR are configured to detect the number of rotations, i.e., a rotation speed, of the rear wheels 10RL and 10RR, respectively.

The wheel speed sensors 12 may each include a contactless sensor configured to detect a change in a magnetic field caused by a rotor that rotates with a corresponding one of the wheels 10, i.e., a gear rotor or a magnetic rotor. The wheel speed sensors 12 may use, for example, a method of detecting the rotation of the rotor by a magnetic pickup, a Hall element, a MR element, or the like. The wheel speed sensors 12 may be coupled to an EV-CU 60 described later.

With such a configuration, in the electric all-wheel-drive vehicle 1 (hereinafter, also simply referred to as the “vehicle 1”), the front wheels 10FL are 10FR are driven by the front motor generator 21, and the rear wheels 10RL and 10RR are driven by the rear motor generator 22. Thus, the balance between the driving force of the front motor generator 21 and the driving force of the rear motor generator 22 is controlled, and the driving forces of the front and rear wheels 10 are variably distributed with any distribution ratio. On the occasion of braking or the like, the regeneration may be performed by the front motor generator 21 and the rear motor generator 22.

Driving of the front motor generator 21 and the rear motor generator 22 may be generally controlled by the EV-CU 60. The EV-CU 60 may be communicatably coupled to, for example, a vehicle dynamics control unit (hereinafter referred to as a “VDCU”) 50 through a CAN (Controller Area Network) 100. The VDCU 50 is configured to suppress a sideslip of the vehicle and enhance travel stability.

The EV-CU 60 and the VDCU 50 may include, for example, a microprocessor, an EEPROM, a RAM, a back-up RAM, and an input output interface (I/F). The microprocessor may perform calculation. The EEPROM may hold, for example, a program that causes the microprocessor to execute processing. The RAM may hold various kinds of data such as calculation results. The back-up RAM may hold contents of storage held by the RAM.

To the VDCU 50, for example, a steering angle sensor 16, a longitudinal acceleration rate (longitudinal G) sensor 55, a lateral acceleration rate (lateral G) sensor 56, a yaw rate sensor 57, and a brake switch 58 may be coupled. The longitudinal acceleration rate sensor 55 may detect an acceleration rate in a longitudinal direction acting on the vehicle 1, and the lateral acceleration rate sensor 56 may detect an acceleration rate in a lateral direction, i.e., a vehicle widthwise direction, acting on the vehicle 1. The steering angle sensor 16 may detect a rotational angle of a pinion shaft, and thereby detect a turning angle of the front wheels 10FL and 10FR as steered wheels, i.e., a steering wheel angle of a steering wheel 15. The yaw rate sensor 57 may detect a yaw rate of the vehicle 1.

The VDCU 50 may brake the vehicle by driving a brake actuator in accordance with an amount of operation of a brake pedal, i.e., an amount of stepping down of the brake pedal. Moreover, the VDCU 50 may detect vehicle behavior by various sensors, e.g., the wheel speed sensors 12, the steering angle sensor 16, the longitudinal acceleration rate sensor 55, the lateral acceleration rate sensor 56, and the yaw rate sensor 57, and suppress the sideslip by a brake control by automatic pressurization and a motor torque control, to ensure vehicle stability on the occasion of cornering. That is, for example, when the vehicle enters a corner at an overspeed or when a posture, or behavior, of the vehicle is disturbed because of, for example, a sudden operation of the steering wheel, the VDCU 50 may suppress the sideslip and ensure excellent travel stability. In addition to the VDC (anti-slip) control mentioned above, the VDCU 50 may have an ABS (anti-lock brake) control and a TCS (traction control) control.

The VDCU 50 may transmit, for example, the steering angle, the longitudinal acceleration rate, the lateral acceleration rate, the yaw rate, and braking data that have been detected, to the EV-CU 60 through the CAN 100.

To the EV-CU 60, various sensors may be coupled. Non-limiting examples of the various sensors may include an accelerator sensor 61, a resolver 62, a resolver 63, and the wheel speed sensors 12. The accelerator sensor 61 may detect an amount of stepping down of an accelerator pedal, i.e., an amount of operation of the accelerator pedal. The resolver 62 may detect a rotation position, or the number of revolutions, of the front motor generator 21. The resolver 63 may detect a rotation position, or the number of revolutions, of the rear motor generator 22. The wheel speed sensors 12 may include the front wheel speed sensors 12FL and 12FR, and the rear wheel speed sensors 12RL and 12RR, and may detect a speed of the wheels 10. Moreover, to the EV-CU 60, for example, temperature sensors 64 and 65, and an oil temperature sensor 66 may be coupled. The temperature sensors 64 and 65 may detect temperatures of the front motor generator 21 and the rear motor generator 22. The oil temperature sensor 66 may detect an oil temperature, i.e., a temperature of oil that lubricates and cools the front reduction gear and the front differential, i.e., the front motor unit, and the rear reduction gear and the rear differential, i.e., the rear motor unit.

Moreover, the EV-CU 60 may receive various kinds of data such as the steering angle, the longitudinal acceleration rate, the lateral acceleration rate, the yaw rate, and the braking data from the VDCU 50 through the CAN 100.

The EV-CU 60 may make a general control of the driving of the front motor generator 21 and the rear motor generator 22 based on the various kinds of data acquired. The EV-CU 60 may obtain a torque command value, i.e., requested electric power, of each of the front motor generator 21 and the rear motor generator 22 based on, for example, an amount of operation of an accelerator, the number of rotations of the front wheels, the number of rotations of the rear wheels, a vehicle speed, i.e., a vehicle body speed, and a state of charge (SOC) of a high-voltage battery 71. The vehicle speed may be obtained from the number of rotations of the front wheels and the number of rotations of the rear wheels, i.e., a wheel speed of the front wheels and a wheel speed of the rear wheels. In one embodiment of the disclosure, the EV-CU 60 may serve as “one or more processors.”

At this occasion, for example, the EV-CU 60 may control the output torque of the front motor generator 21 and the output torque of the rear motor generator 22, to provide longitudinal distribution of the driving force in accordance with a frictional force with respect to a road surface, i.e., a slip ratio, of the front wheels 10FL and 10FR, and the rear wheels 10RL and 10RR, during a normal control. It is to be noted that the EV-CU 60 may obtain, for example, grounding loads of the front wheels 10FL and 10FR, and the rear wheels 10RL and 10RR from the longitudinal acceleration rate and the lateral acceleration rate of the vehicle, and estimate the frictional force with respect to the road surface based on the grounding loads.

A power control unit (hereinafter referred to as a “PCU”) 70 may drive the front motor generator 21 and the rear motor generator 22 through an inverter 70a based on the torque command value, i.e., the requested electric power. The inverter 70a may convert DC power of the high-voltage battery 71 into three-phase AC power and supply the resultant power to each of the front motor generator 21 and the rear motor generator 22. During the regeneration, the inverter 70a may convert an AC voltage generated by the front motor generator 21 and/or the rear motor generator 22 into a DC voltage, and charge the high-voltage battery 71.

In addition, the EV-CU 60 is configured to make a cruise control. The cruise control includes maintaining the vehicle speed at a set speed regardless of an accelerator operation by a driver. In one example, when an execution switch of the cruise control is operated by the driver and a target vehicle speed, i.e., the set vehicle speed is set, the EV-CU 60 may control, for example, the output torque of the front motor generator 21 and the output torque of the rear motor generator 22 to maintain the vehicle speed at the target vehicle speed thus set, i.e., the set vehicle speed. It is to be noted that the cruise control is assumed to include a cruise control including preceding-vehicle tracking, i.e., an adaptive cruise control (ACC). The ACC control includes controlling a subject vehicle to, when no preceding vehicles are detected, travel at a constant speed, and controlling the subject vehicle to, when a preceding vehicle is detected, follow the preceding vehicle.

In particular, the EV-CU 60 is configured to further improve the electricity consumption of the electric all-wheel-drive vehicle 1. In the EV-CU 60, the improvement of the electricity consumption may be realized by the microprocessor executing the program held in the EEPROM or the like.

The electricity consumption of the electric all-wheel-drive vehicle is influenced by travel resistance, and the travel resistance is influenced by the longitudinal distribution of the driving force. Examples of the influence on the travel resistance, i.e., the electricity consumption, by the longitudinal distribution of the driving force may include an influence of efficiency of the front and rear motor units and an influence of compliance steer caused by driving front and rear tires. The compliance steer is a change in an actual steering angle caused by deflection of a suspension, a steering wheel, etc. These influences change with, for example, the temperatures of the front and rear motor generators 21 and 22, the oil temperature of the motor units, and a state of wheel alignment of the motor units.

Thus, the EV-CU 60 is configured to, when a predetermined learning condition is established, vary, or change, the output torque of the rear motor generator 22 and the output torque of the front motor generator 21, while satisfying requested torque, i.e., a requested driving force, and learn the longitudinal differential rotation at which the total power consumption or the total torque of the front motor generator 21 and the rear motor generator 22 is minimized, or takes a minimum value. The longitudinal differential rotation is a difference between the number of rotations of the front wheels and the number of rotations of the rear wheels.

In one example, to minimize influences on operation stability, the EV-CU 60 may determine that the predetermined learning condition is established, when the cruise control is in operation and the steering angle is equal to or smaller than a predetermined value, that is, the vehicle is on straight travel or substantially on straight travel, and learn the longitudinal differential rotation. The steering angle may be the steering wheel angle or the turning angle.

When the cruise control is in operation, the requested torque, i.e., the requested driving force, may be acquired in accordance with, for example, a deviation between the set vehicle speed, i.e., the target vehicle speed, and an actual vehicle speed. Otherwise than when the cruise control is in operation, the requested torque, i.e., the requested driving force, may be acquired based on, for example, the amount of operation of the accelerator and the vehicle speed.

In one example, when learning the longitudinal differential rotation, the EV-CU 60 may increase the output torque of the rear motor generator 22, i.e., rear torque, and reduce the output torque of the front motor generator 21, i.e., front torque, with an FF (front-engine front-wheel drive) method as a reference, or a base. The front torque equals a subtraction of the rear torque from the requested torque. It is to be noted that, when increasing an output of the rear motor generator 22 and correspondingly reducing an output of the front motor generator 21, the slip ratio of the rear wheels 10RL and 10RR, and the slip ratio of the front wheels 10FL and 10FR each change as described later in detail, causing a change in the longitudinal differential rotation.

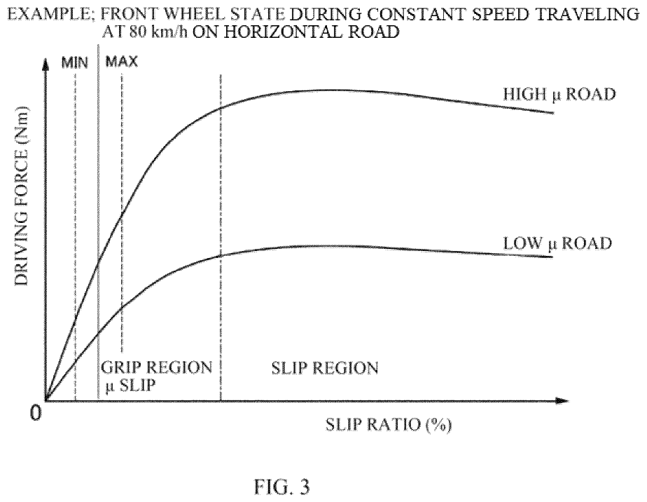

In one example, when learning the longitudinal differential rotation, the EV-CU 60 may vary, or change, the output torque of the rear motor generator 22 and the output torque of the front motor generator 21, to allow the slip ratio of the front wheels 10FL and 10FR, and the slip ratio of the rear wheels 10RL and 10RR to fall within a predetermined range of the slip ratio, e.g., about ±2%, between MIN and MAX illustrated in FIG. 3, that is, at a level that the wheels do not lose grip.

FIG. 3 illustrates characteristics of, or relation between, the driving force and a tire slip, i.e., the slip ratio. In FIG. 3, the vertical axis represents the driving force (Nm), and the horizontal axis represents the slip ratio (%). FIG. 3 illustrates the characteristics of, or the relation between, a case of a low u road (low friction road) and a case of a high u road (high friction road). As illustrated in FIG. 3, as the driving force becomes larger, the slip ratio also becomes higher. Thus, the slip ratio goes over a peak of the driving force and enters a slip region. That is, the slip ratio reaches a limit at which a tire cannot transmit any more driving force. Accordingly, as described above, when increasing the output of the rear motor generator 22 and correspondingly reducing the output of the front motor generator 21, the slip ratio of the rear wheels 10RL and 10RR becomes higher, and the slip ratio of the front wheels 10FL and 10FR becomes lower, causing a change in the longitudinal differential rotation.

Moreover, by varying the output torque of the rear motor generator 22 and the output torque of the front motor generator 21 to allow the slip ratio of the front wheels 10FL and 10FR, and the slip ratio of the rear wheels 10RL and 10RR to fall within the predetermined range of the slip ratio, e.g., about ±2%, between the MIN to the MAX illustrated in FIG. 3, it is possible to stably learn the longitudinal differential rotation while maintaining the grip even on the low u road, regardless of a friction coefficient u of the road surface. When the front and rear wheels 10 are assumed to have the same diameter and the same axle load, it is possible to regard the longitudinal differential rotation as being substantially equal to a difference in the slip ratio. Accordingly, restricting the longitudinal differential rotation leads to suppression of an abnormal slip ratio. That is, determining the longitudinal distribution of the driving force by a torque control causes possibility of an unintended slip of the wheels 10, i.e., the entry into the slip region, on, for example, a low μ road, i.e., a road surface with a large increase in the slip ratio per 1 Nm. Thus, a search range for the learning is limited by the difference in the number of rotations between the front and rear wheels 10 that is substantially equal to the difference in the slip ratio.

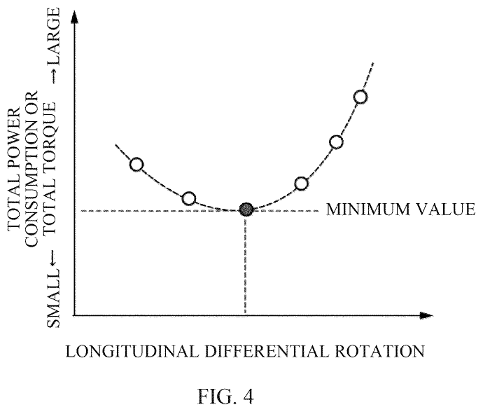

FIG. 4 is provided for description of a learning method of the minimum value of the total power consumption or the total torque. In FIG. 4, the horizontal axis represents the longitudinal differential rotation (rpm), and the vertical axis represents the total power consumption (kWh) or the total torque (Nm). It is to be noted that a known method or algorithm may be used as a method of searching for the longitudinal differential rotation at which the total power consumption or the total torque takes the minimum value.

Back to FIG. 1, after learning the longitudinal differential rotation, the EV-CU 60 may control, or make a feedback (F/B) control of, the output torque of the rear motor generator 22 and the output torque of the front motor generator 21, to allow the actual longitudinal differential rotation to match with the learned longitudinal differential rotation, i.e., the target longitudinal differential rotation.

In one example, after learning the longitudinal differential rotation, when the cruise control is in operation and the steering is equal to or smaller than the predetermined value, the EV-CU 60 may control, or make the F/B control of, the output torque of the rear motor generator 22, i.e., the rear torque, and the output torque of the front motor generator 21, i.e., the front torque, to allow the actual longitudinal differential rotation to match with the learned longitudinal differential rotation, i.e., the target longitudinal differential rotation. The front torque equals the subtraction of the rear torque from the requested torque. The steering angle may be the steering wheel angle or the turning angle.

In an alternative configuration, the learning of the longitudinal differential rotation may be repeated to sequentially update a learning value, to use, or control, the latest learning value as a target value, i.e., the target longitudinal differential rotation. In another alternative configuration, a map of the acquired learning data may be created for use.

In the case where the map of the acquired learning data is created, in one example, the EV-CU 60 may learn the longitudinal differential rotation for each vehicle speed and for each requested torque.

Thus, the EV-CU 60 may generate a target longitudinal difference rotation map that defines relation between the vehicle speed, the requested driving force, and the learned longitudinal differential rotation.

After the generation of the target longitudinal differential rotation map, when the cruise control is in operation and the steering angle is equal to or smaller than the predetermined value, that is, the vehicle is on the straight travel or substantially on the straight travel, the EV-CU 60 may control the output torque of the front motor generator 21 and the output torque of the rear motor generator 22 using the target longitudinal differential rotation map. The steering angle may be the steering wheel angle or the turning angle.

That is, the EV-CU 60 may store, in the EEPROM or the like, the target longitudinal differential rotation map, i.e., the map that defines the relation between the vehicle speed, the requested torque, and the learned longitudinal differential rotation, i.e., the target longitudinal differential rotation, and search the target longitudinal differential rotation map based on the vehicle speed and the requested torque, and thereby obtain the target longitudinal differential rotation. Thus, based on the target longitudinal differential rotation, the EV-CU 60 may control the output torque of the front motor generator 21 and the output torque of the rear motor generator 22.

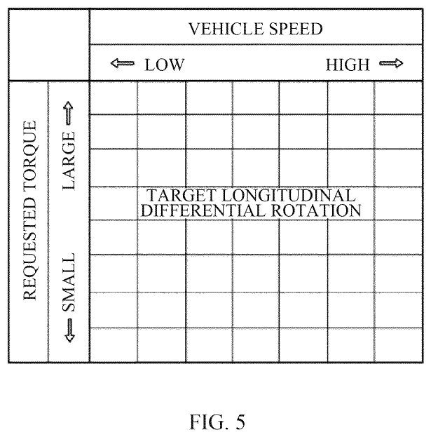

FIG. 5 illustrates an example of the target longitudinal differential rotation map. In FIG. 5, the horizontal axis represents the vehicle speed (km/h), and the vertical axis represents the requested torque (Nm). The target longitudinal differential rotation map holds the learned longitudinal differential rotation, i.e., the target longitudinal differential rotation, for each combination, i.e., each lattice point, of the vehicle speed and the requested torque.

In addition, the EV-CU 60 may learn the longitudinal differential rotation for each temperature of the front motor generator 21, for each temperature of the rear motor generator 22, and for each oil temperature, i.e., for each temperature of the oil that lubricates and cools the front and rear motor units. Alternatively, the EV-CU 60 may learn the longitudinal differential rotation for each temperature of the front motor generator 21 and for each temperature of the rear motor generator 22. In another alternative, the EV-CU 60 may learn the longitudinal differential rotation for each oil temperature. The EV-CU 60 may add these parameters to the axes of the target longitudinal differential rotation map described above.

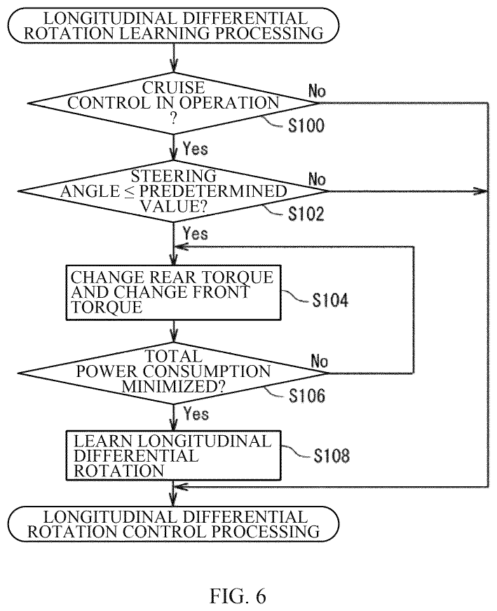

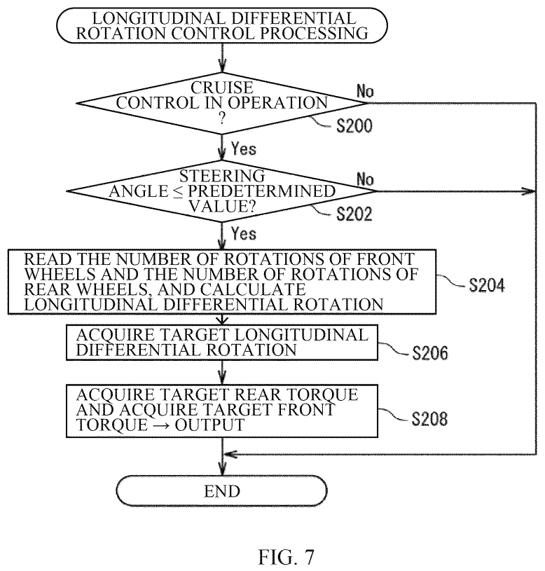

With reference to FIGS. 6 and 7, description now moves on to operation of the electric all-wheel-drive vehicle 1. FIG. 6 is a flowchart of a processing procedure of learning processing of the longitudinal differential rotation. FIG. 7 is a flowchart of a processing procedure of a longitudinal differential rotation control. The processing may be carried out repeatedly at predetermined timing in, for example, the EV-CU 60.

First, with reference to FIG. 6, the processing procedure of the learning processing of the longitudinal differential rotation is described. In step S100, a determination may be made as to whether the cruise control is in operation. When the cruise control is not in operation, the flow may end temporarily. When the cruise control is in operation, the flow may proceed to step S102.

In step S102, a determination may be made as to whether the steering angle is equal to or smaller than the predetermined value, that is, whether the vehicle is on the straight travel or substantially on the straight travel. The steering angle may be the steering wheel angle or the turning angle. When the steering angle is larger than the predetermined value, the flow may end temporarily. When the steering angle is equal to or smaller than the predetermined value, the flow may proceed to step S104.

In step S104, the output torque of the rear motor generator 22 and the output torque of the front motor generator 21 may be varied while satisfying the requested torque. For example, the output torque of the rear motor generator 22, i.e., the rear torque, may be increased, and the output torque of the front motor generator 21, i.e., the front torque, may be correspondingly reduced. The front torque equals the subtraction of the rear torque from the requested torque.

Thereafter, in step S106, a determination may be made as to whether the total power consumption or the total torque of the front motor generator 21 and the rear motor generator 22 is minimized. That is, a determination may be made as to whether the total power consumption or the total torque has taken the minimum value. When the total power consumption or the total torque is not minimized, the processing of steps S104 to S106 described above may be repeated until the total power consumption or the total torque is minimized. In one example, in step S104, the output torque of the rear motor generator 22, i.e., the rear torque, may be further increased, and the output torque of the front motor generator 21, i.e., the front torque, may be correspondingly reduced. The front torque equals the subtraction of the rear torque from the requested torque. Thereafter, in step S106, a determination may be made again as to whether the total power consumption or the total torque of the front motor generator 21 and the rear motor generator 22 is minimized, i.e., whether the total power consumption or the total torque has taken the minimum value. When the total power consumption or the total torque of the front motor generator 21 and the rear motor generator 22 is minimized, the flow may proceed to step S108.

In step S108, the longitudinal differential rotation at which the total power consumption or the total torque of the front motor generator 21 and the rear motor generator 22 is minimized is learned and stored. The longitudinal differential rotation is the difference between the number of rotations of the front wheels and the number of rotations of the rear wheels. Thereafter, the flow may end temporarily.

With reference to FIG. 7, description is given next of the processing procedure of the longitudinal differential rotation control. In step S200, a determination may be made as to whether the cruise control is in operation. When the cruise control is not in operation, the flow may end temporarily. When the cruise control is in operation, the flow may proceed to step S202.

In step S202, a determination may be made as to whether the steering angle is equal to or smaller than the predetermined value, i.e., whether the vehicle is on the straight travel or substantially on the straight travel. The steering angle may be the steering wheel angle or the turning angle. When the steering angle is larger than the predetermined value, the flow may end temporarily. When the steering angle is equal to or smaller than the predetermined value, the flow may proceed to step S204.

In step S204, the number of rotations of the front wheels 10FL and 10FR, and the number of rotations of the rear wheels 10RL and 10RR may be read, and the actual longitudinal differential rotation may be calculated. The actual longitudinal differential rotation is a subtraction of the number of rotations of the rear wheels from the number of rotations of the front wheels.

Thereafter, in step S206, the learned latest longitudinal differential rotation, i.e., the target longitudinal differential rotation, may be read. Alternatively, the target longitudinal differential rotation map may be searched based on the vehicle speed and the requested torque, to obtain the target longitudinal differential rotation.

Thereafter, in step S208, the output torque of the rear motor generator 22, i.e., the rear torque, and the output torque of the front motor generator 21, i.e., the front torque, may be controlled, or subjected to the F/B control, to allow the target longitudinal difference rotation and the actual longitudinal difference rotation to match with each other. The front torque equals the subtraction of the rear torque from the requested torque. Thereafter, the flow may end temporarily.

As described above in detail, according to the embodiment, when the predetermined learning condition is established, the output torque of the rear motor generator 22 and the output torque of the front motor generator 21 are varied, while satisfying the requested torque, to learn the longitudinal differential rotation at which the total power consumption or the total torque of the front motor generator 21 and the rear motor generator 22 is minimized. The longitudinal differential rotation is the difference between the number of rotations of the front wheels and the number of rotations of the rear wheels. After learning the longitudinal differential rotation, the output torque of the front motor generator 21 and the output torque of the rear motor generator 22 are controlled to allow the actual longitudinal differential rotation to match with the learned longitudinal differential rotation. This makes it possible to control the longitudinal distribution of the driving force to minimize the total power consumption or the total torque of the front motor generator 21 and the rear motor generator 22, while satisfying the requested torque, leading to further improvement of the electricity consumption. As a result, in the electric all-wheel-drive vehicle 1 in which the front wheels 10FL and 10FR are driven by the front motor generator 21 and the rear wheels 10RL and 10RR are driven by the rear motor generator 22, it is possible to further improve the electricity consumption. Furthermore, by learning the longitudinal differential rotation, it is also possible to absorb, for example, individual differences and temporal changes, or degradation.

Moreover, according to the embodiment, when the cruise control is in operation and the steering angle is equal to or smaller than the predetermined value, the determination may be made that the predetermined learning condition is established, and the longitudinal differential rotation is learned. After learning the longitudinal differential rotation, when the cruise control is in operation, and the steering angle is equal to or smaller than the predetermined value, the output torque of the front motor generator 21 and the output torque of the rear motor generator 22 may be controlled to allow the actual longitudinal differential rotation and the learned longitudinal differential rotation, i.e., the target longitudinal differential rotation, to match with each other. Hence, it is possible to minimize the influences on the operation stability.

According to the embodiment, the output torque of the rear motor generator 22 and the output torque of the front motor generator 21 may be varied to allow the slip ratio of the front wheels 10FL and 10FR, and the slip ratio of the rear wheels 10RL and 10RR to fall within the predetermined range of the slip ratio. Hence, it is possible to suppress an abnormal, or excessive, slip of the wheels 10.

According to the embodiment, the longitudinal differential rotation may be learned for each vehicle speed and for each requested torque. Hence, it is possible to create the map in consideration of the changes in the travel resistance in accordance with the changes in the vehicle speed and the requested torque.

Moreover, according to the embodiment, the longitudinal differential rotation may be learned for each temperature of the front motor generator 21, for each temperature of the rear motor generator 22, and for each oil temperature, i.e., the temperature of the oil. Alternatively, the longitudinal differential rotation may be learned for each temperature of the front motor generator 21 and for each temperature of the rear motor generator 22. In another alternative, the longitudinal differential rotation may be learned for each oil temperature. Hence, it is possible to create the map in consideration of the changes in the travel resistance in accordance with the changes in the temperatures of the front and rear motor generators 21 and 22, and/or the oil temperature.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, in the forgoing embodiment, the disclosure is applied to the electric all-wheel-drive vehicle 1 in which the front wheels 10FL and 10FR are driven by the front motor generator 21, and the rear wheels 10RL and 10RR are driven by the rear motor generator 22. However, the disclosure is applicable to, for example, an electric all-wheel-drive vehicle in which an in-wheel motor is attached to each of the four wheels.

In the forgoing embodiment, the EV-CU 60 is configured to, when the cruise control is in operation and the steering angle is equal to or smaller than the predetermined value, determine that the predetermined learning condition is established, and learn the longitudinal differential rotation. However, this is non-limiting. When the cruise control is in operation and the steering angle is smaller than the predetermined value, the EV-CU 60 may determine that the predetermined learning condition is established, and learn the longitudinal differential rotation.

In the forgoing embodiment, after learning the longitudinal differential rotation, the EV-CU 60 is configured to, when the cruise control is in operation and the steering angle is equal to or smaller than the predetermined value, control the output torque of the front electric motor and the output torque of the rear electric motor to allow the actual longitudinal differential rotation to match with the learned longitudinal differential rotation. However, this is non-limiting. After learning the longitudinal differential rotation, when the cruise control is in operation and the steering angle is smaller than the predetermined value, the EV-CU 60 may control the output torque of the front electric motor and the output torque of the rear electric motor to allow the actual longitudinal differential rotation to match with the learned longitudinal differential rotation.

Moreover, the system configuration of the controllers such as the EV-CU 60 and the VDCU 50, and the sharing of the operation of the controllers are not limited to the forgoing embodiment. For example, in the forgoing embodiment, the wheel speed sensors 12 are coupled to the EV-CU 60. However, in an alternative configuration, the wheel speed sensors 12 may be coupled to the VDCU 50, and the detection results may be transmitted to the EV-CU 60 through the CAN 100. Furthermore, in the forgoing embodiment, the EV-CU 60, the PCU 70, and the VDCU 50 are communicatably coupled together through the CAN 100. However, the system configuration is not limited to such a configuration, but may be changed, e.g., for integration, in view of, for example, functional requirements, costs, and the like.

The EV-CU 60 and the VDCU 50 illustrated in FIG. 1 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the EV-CU 60 and the VDCU 50. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the EV-CU 60 and the VDCU 50 illustrated in FIG. 1.

1. An electric all-wheel-drive vehicle comprising:
a front electric motor configured to drive a front wheel;
a rear electric motor configured to drive a rear wheel;
an accelerator sensor configured to detect an amount of operation of an accelerator;
a front wheel speed sensor configured to detect a number of rotations of the front wheel;
a rear wheel speed sensor configured to detect a number of rotations of the rear wheel;
one or more processors configured to control the front electric motor and the rear electric motor based on the amount of operation of the accelerator, the number of rotations of the front wheel, and the number of rotations of the rear wheel,
the one or more processors being configured to,
when a predetermined learning condition is established, vary output torque of the rear electric motor and output torque of the front electric motor, while satisfying requested torque, to learn longitudinal differential rotation at which total power consumption or total torque of the front electric motor and the rear electric motor is minimized, the longitudinal differential rotation being a difference between the number of rotations of the front wheel and the number of rotations of the rear wheel, and
after learning the longitudinal differential rotation, control the output torque of the front electric motor and the output torque of the rear electric motor to allow actual longitudinal differential rotation to match with the learned longitudinal differential rotation.

2. The electric all-wheel-drive vehicle according to claim 1, wherein
the one or more processors are configured to, when the predetermined learning condition is established, vary the output torque of the rear electric motor and the output torque of the front electric motor, while satisfying the requested torque, to allow a slip ratio of the front wheel and a slip ratio of the rear wheel to fall within a predetermined range of the slip ratio.

3. The electric all-wheel-drive vehicle according to claim 2, wherein
the one or more processors are configured to, when a cruise control is in operation and a steering angle is smaller than a predetermined
value, determine that the predetermined learning condition is established, and learn the longitudinal differential rotation,
after learning the longitudinal differential rotation, when the cruise control is in operation and the steering angle is smaller than the predetermined value, control the output torque of the front electric motor and the output torque of the rear electric motor to allow the actual longitudinal differential rotation to match with the learned longitudinal differential rotation.

4. The electric all-wheel-drive vehicle according to claim 3, wherein
the one or more processors are configured to learn the longitudinal differential rotation for each vehicle speed and for each requested torque.

5. The electric all-wheel-drive vehicle according to claim 4, wherein
the one or more processors are configured to learn the longitudinal differential rotation for each temperature of the front electric motor, for each temperature of the rear electric motor, and for each oil temperature.

6. The electric all-wheel-drive vehicle according to claim 4, wherein
the one or more processors are configured to learn the longitudinal differential rotation for each temperature of the front electric motor and for each temperature of the rear electric motor.

7. The electric all-wheel-drive vehicle according to claim 4, wherein
the one or more processors are configured to learn the longitudinal differential rotation for each oil temperature.
